(19) United States
(12) Patent Application Publication
(10) Pub. No.: US 2003/0124288 A1
(43) Pub. Date: Jul. 3, 2003

(54) Polyamide- and EVOH-based conducting multilayer tube for transporting petrol

(75) Inventors: Joachim Merziger, Evreux (FR); Christophe Lacroix, Harquency (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/301,826

(22) Filed: Nov. 22, 2002

(30) Foreign Application Priority Data
Nov. 22, 2001 (FR) 01.15115
Feb. 14, 2002 (FR) 02.01840

(51) Int. Cl. B32B 1/08

(52) U.S. Cl. 428/36.91

(57) ABSTRACT

The present invention relates to a multilayer tube comprising, in its radial direction from the outside inwards:

an outer layer formed from a polyamide chosen from PA-11 and PA-12,

a layer formed from a tie compound,

a layer formed from an EVOH,

a layer formed from a blend of a polyamide and a polyolefin having a polyamide matrix

a layer from a tie compound

an inner layer formed from a polyamide chosen from PA-11 and PA-12 and including a dispersed electrically conducting filler producing a surface resistivity of less than 10⁶Ω-□,

the layers being successive and adhering to one another in their respective contact region.

The tube of the present invention has a very low permeability to petrol, particularly to hydrocarbons and their additives, and in particular to alcohols, such as methanol and ethanol, or to ethers, such as MTBE or ETBE. These tubes also have good resistance to engine lubrication oils and fuels.

The tube has very good mechanical properties at low or high temperatures.

### FIELD OF THE INVENTION

The present invention relates to tubes, based on polyamides and EVOH (an ethylene/vinyl alcohol copolymer), for transporting petrol, and in particular for conveying the petrol from the tank to the engine of a motor vehicle.

For safety and environmental protection reasons, motor-vehicle manufacturers require these tubes to have both mechanical properties such as strength and flexibility with good cold (−40° C.) impact strength as well as good high-temperature (125° C.) strength, and also very low permeability to hydrocarbons and to their additives, particularly alcohols such as methanol and ethanol. These tubes must also have good resistance to the fuels and lubrication oils for the engine. In motor vehicles, owing to the effect of the injection pump, the petrol flows at high speed in the pipes connecting the engine to the tank. In certain cases, friction between the petrol and the internal wall of the tube can generate electrostatic charges, the build-up of which may result in an electrical discharge (a spark) capable of igniting the petrol with catastrophic consequences (an explosion). It is therefore necessary to make the inner surface of the tube in contact with the petrol conducting.

These tubes are manufactured by coextruding the various layers using standard techniques for thermoplastics.

### PRIOR ART AND TECHNICAL PROBLEM

Among the characteristics of the specification for these tubes, five are particularly difficult to obtain jointly in a simple manner:

cold (−40° C.) impact strength—the tube does not break;

fuel resistance;

high-temperature (125° C.) strength;

very low permeability to petrol;

good dimensional stability of the tube in use with the petrol.

In multilayer tubes of various structures, the cold impact strength remains unpredictable before having carried out the standardized tests for cold impact strength.

Moreover, it is already known from Patent Application EP 0 781 799 that in motor vehicles, owing to the effect of the injection pump, the petrol flows at high speed in the pipes connecting the engine to the tank. In certain cases, friction between the petrol and the internal wall of the tube can generate electrostatic charges, the build-up of which may result in an electrical discharge (a spark) capable of igniting the petrol with catastrophic consequences (an explosion). It is therefore necessary to limit the surface resistivity of the internal face of the tube to a value of generally less than 10⁶ ohms/square. It is known to lower the surface resistivity of polymeric resins or materials by incorporating conductive and/or semiconductive materials into them, such as carbon black, steel fibres, carbon fibres, and particles (fibres, platelets or spheres) metallized with gold, silver or nickel.

Among these materials, carbon black is more particularly used, for economic and processability reasons. Apart from its particular electrically conductive properties, carbon black behaves as a filler such as, for example, talc, chalk or kaolin. Thus, those skilled in the art know that when the filler content increases, the viscosity of the polymer/filler blend increases. Likewise, when the filler content increases, the flexural modulus of the filled polymer increases. These known and predictable phenomena are explained in “Handbook of Fillers and Reinforcements for Plastics”, edited by H. S. Katz and J. V. Milewski—Van Nostrand Reinhold Company—ISBN 0-442-25372-9, see in particular Chapter 2, Section II for fillers in general and Chapter 16, Section VI for carbon black in particular.

As regards the electrical properties of carbon black, the technical report “Ketjenblack EC—BLACK 94/01” by Akzo Nobel indicates that the resistivity of the formulation drops very suddenly when a critical carbon black content, called the percolation threshold, is reached. When the carbon black content increases further, the resistivity rapidly decreases until reaching a stable level (plateau region). It is therefore preferred, for a given resin, to operate in the plateau region in which a metering error will have only a slight effect on the resistivity of the compound.

Polyamide- and EVOH-based tubes for transporting petrol are also known from Patent Application EP 0 731 308. These tubes may have a four-layer structure comprising, respectively, a PA-12 outer layer, a binder layer, which is a grafted polyolefin, an EVOH layer and an inner layer in contact with the petrol, comprising a blend of a polyamide and a polyolefin having a polyamide matrix.

Patent EP 428833 describes a three-layer tube comprising, respectively, a PA-12 outer layer, a binder layer which is a grafted polyolefin and an EVOH inner layer in contact with the petrol.

Patents EP 428834 and EP 477606 describe a five-layer tube comprising, respectively, a PA-12 outer layer, a binder layer which is a grafted polyolefin, a PA-6 layer, an EVOH layer and a PA-6 inner layer in contact with the petrol.

U.S. Pat. No. 5,038,833 describes a three-layer tube comprising, respectively, a PA-12 outer layer, an EVOH layer and a PA-12 inner layer in contact with the petrol.

All these tubes have good properties but the thickness of the binder layers is not easy to control and as a result, there may be delaminations. In the tube described in U.S. Pat. No. 5,038,833, there is no binder but delaminations do occur.

Patent EP 1 036 967 describes a polyamide-based multilayer tube, characterized in that it comprises, in its radial direction from inside outwards:

an inner layer formed from a polyamide or from a blend of a polyamide and a polyolefin having a polyamide matrix, this layer including a dispersed filler of an electrically conducting carbon black producing a surface resistivity of less than 10⁶ Ω/□,

an interlayer formed from a polyamide or from a blend of a polyamide and a polyolefin having a polyamide matrix, this layer not including the electrically conducting carbon black or not an electrically significant quantity of this carbon black,

an EVOH layer,

a tie layer,

a polyamide outer layer,

the above layers adhering to one another in their respective contact region.

This tube has very good mechanical and petrol-impermeability properties, but it has been discovered that if the conducting inner layer is based on PA-11 or PA-12 and if the interlayer is based on a blend of a polyamide and a polyolefin having a polyamide matrix, then this is a very good compromise between conductivity and the barrier properties of the tube. However, the adhesion between this conducting inner layer and the interlayer is not perfect. This imperfect adhesion does not affect the cold impact resistance, which remains the most important mechanical criterion, however, should the tube be under a partial vacuum, then the inner layer partly delaminates and the tube is at risk of being blocked. It is therefore necessary to place between these two layers a coextruded tie layer.

### BRIEF DESCRIPTION OF THE INVENTION

The present invention relates to a multilayer tube comprising, in its radial direction from the outside inwards:

an outer layer formed from a polyamide chosen from PA-11 and PA-12,

a layer formed from a tie compound,

a layer formed from an EVOH,

a layer formed from a blend of a polyamide and a polyolefin having a polyamide matrix,

a layer from a tie compound,

an inner layer formed from a polyamide chosen from PA-11 and PA-12 and including a dispersed electrically conducting filler producing a surface resistivity of less than 10⁶ Ω/□,

the layers being successive and adhering to one another in their respective contact region.

Advantageously, the tube according to the invention has an outside diameter ranging from 6 to 12 mm and a total thickness of 0.38 mm to 2 mm, namely:

a thickness of 300 to 800 μm for the nylon-11 or nylon-12 (PA-11 or PA-12) outer layer;

a thickness of 10 to 100 μm for the EVOH layer;

a thickness of 25 to 500 μm for the layer formed from a blend of a polyamide or polyolefin having a polyamide matrix;

a thickness of 25 to 300 μm for the polyamide inner layer filled with an electrically conducting filler.

The tube of the present invention has a very low permeability to petrol, particularly to hydrocarbons and their additives, and in particular to alcohols, such as methanol and ethanol, or to ethers, such as MTBE or ETBE. These tubes also have good resistance to engine lubrication oils and fuels.

This tube has very good mechanical properties at low or high temperature.

### DETAILED DESCRIPTION OF THE INVENTION

With regard to the outer layer made of PA-11 (nylon-11) or PA-12 (nylon-12), these polyamides advantageously have a number-average molecular mass \overline{M}ₙ generally greater than or equal to 5000. Their inherent viscosity (measured at 20° C.) for a 0.5 g sample in 100 g of meta-cresol) is in general greater than 0.7.

Advantageously, this polyamide of the outer layer is plasticized by standard plasticizers such as n-butyl benzene sulphonamide (BBSA) and copolymers comprising polyamide blocks and polyether blocks.

The copolymers having polyamide blocks and polyether blocks result from the copolycondensation of polyamide blocks having reactive ends with polyether blocks having reactive ends, such as, inter alia:

1) polyamide blocks having diamine chain ends with polyoxyalkylene blocks having dicarboxylic chain ends;

2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols;

3) polyamide blocks having dicarboxylic chain ends with polyetherdiols, the products obtained being, in this particular case, polyetheresteramides. Advantageously, these copolymers are used.

Polyamide blocks having dicarboxylic chain ends derive, for example, from the condensation of alpha, omega-aminocarboxylic acids, of lactams or of dicarboxylic acids and diamines in the presence of a chain-stopping dicarboxylic acid.

Polyamide blocks having diamine chain ends derive, for example, from the condensation of alpha, omega-aminocarboxylic acids, of lactams or of dicarboxylic acids and diamines in the presence of a chain-stopping diamine. The polyether may, for example, be a polyethylene glycol (PEG), a polypropylene glycol (PPG) or a polytetramethylene glycol (PTMG). The latter is also called polytetrahydrofuran (PTHF).

The number-average molar mass \overline{M}ₙ of the polyamide blocks is between 300 and 15,000 and preferably between 600 and 5000. The mass \overline{M}ₙ of the polyether blocks is between 100 and 6000 and preferably between 200 and 3000.

Polymers having polyamide blocks and polyether blocks may also include randomly distributed units. These polymers may be prepared by the simultaneous reaction of the polyether and polyamide-block precursors.

For example, it is possible to react polyetherdiol, a lactam (or an alpha, omega-amino acid) and a chain-stopping diacid in the presence of a small amount of water. A polymer is obtained having essentially polyether blocks and polyamide blocks of very variable length, but also the various reactants, having reacted in a random fashion, which are distributed randomly along the polymer chain.

These polymers having polyamide blocks and polyether blocks, whether they derive from the copolycondensation of polyamide and polyether blocks prepared beforehand or from a one-step reaction, have, for example, Shore D hardnesses which may be between 20 and 75 and advantageously between 30 and 70 and an intrinsic viscosity of between 0.8 and 2.5 measured in meta-cresol at 25° C. for an initial concentration of 0.8 g/100 ml. The MFIs may be between 5 and 50 (235° C., with a load of 1 kg).

The polyetherdiol blocks are either used as such and copolycondensed with polyamide blocks having carboxylic ends or they are aminated in order to be converted into diamine polyethers and condensed with polyamide blocks having carboxylic ends. They may also be mixed with polyamide precursors and a chain stopper in order to make polyamide-block polyether-block polymers having randomly distributed units.

Polymers having polyamide and polyether blocks are described in U.S. Pat. Nos. 4,331,786; 4,115,475; 4,195,015; 4,839,441; 4,864,014, U.S. Pat. Nos. 4,230,838 and 4,332,920.

The ratio of the amount of copolymer having polyamide blocks and polyether blocks to the amount of polyamide is, by weight, advantageously between 10/90 and 60/40. Mention may also be made, for example, of copolymers having PA-6 blocks and PTMG blocks and copolymers having PA-12 blocks and PTMG blocks.

With regard to the tie layers: these are thus defined as any product allowing good adhesion between the layers in question, that is to say between the PA-11 or PA-12 outer layer and the EVOH layer, and between the layer of a blend of a polyamide and a polyolefin having a polyamide matrix and the PA-11 or PA-12 inner layer. Advantageously, the tie is chosen from copolyamides and functionalized polyolefins.

By way of example of ties based on functionalized polyolefins, mention may be made of

polyethylene, polypropylene, copolymers of ethylene with at least one alpha-olefin, blends of these polymers, all these polymers being grafted by unsaturated carboxylic acid anhydrides, such as for example maleic anhydride, or blends of these grafted polymers and these non-grafted polymers;

copolymers of ethylene with at least one product chosen from (i) unsaturated carboxylic acids, their salts, their esters, (ii) vinyl esters of saturated carboxylic acids (iii) unsaturated dicarboxylic acids, their salts, their esters, their half-esters, their anhydrides and (iv) unsaturated epoxydes, these copolymers possibly being grafted by unsaturated dicarboxylic acid anhydrides, such as maleic anhydride, or unsaturated epoxydes, such as glycidyl methacrylate.

With regard to the copolyamide-type tie layers, the copolyamides that can be used in the present invention have a melting point (DIN 53736B standard) of between 60 and 200° C. and their relative solution viscosity can be between 1.3 and 2.2 (DIN 53727 standard; m-cresol solvent, 0.5 g/100 ml concentration, 25° C. temperature, Ubbelohde viscometer). Their melt rheology is preferably similar to that of the materials of the outer and inner layers.

The copolyamides derive, for example, from the condensation of alpha,omega-aminocarboxylic acids, of lactams or of dicarboxylic acids and diamines.

According to a first type, the copolyamides result from the condensation of at least two alpha,omega-aminocarboxylic acids or of at least two lactams having from 6 to 12 carbon atoms or of a lactam and of an aminocarboxylic acid not having the same number of carbon atoms, in the possible presence of a chain stopper which may, for example, be a monoamine or a diamine or a monocarboxylic acid or a dicarboxylic acid. Among chain stoppers, mention may be made in particular of adipic acid, azelaic acid, stearic acid and dodecanediamine. The copolyamides of this first type may also include units which are residues of diamines and dicarboxylic acids.

By way of examples of dicarboxylic acids, mention may be made of adipic acid, nonanedioic acid, sebacic acid and dodecanedioic acid.

By way of examples of alpha,omega-aminocarboxylic acids, mention may be made of aminocaproic acid, aminoundecanoic acid and aminododecanoic acid.

By way of examples of lactams, mention may be made of caprolactam and lauryllactam (2-azacyclotridecanone).

According to a second type, the copolyamides result from the condensation of at least one alpha,omega-aminocarboxylic acid (or a lactam), at least one diamine and at least one dicarboxylic acid. The alpha,omega-aminocarboxylic acid, the lactam and the dicarboxylic acid may be chosen from those mentioned above.

The diamine may be a branched, linear or cyclic aliphatic diamine or else an aryl-type diamine.

By way of examples, mention may be made of hexamethylenediamine, piperazine, isophoronediamine (IPD), methylpentamethylenediamine (MPDM), bis(aminocyclohexyl)methane (BACM) and bis(3-methyl-4-amino-cyclohexyl)methane (BMACM).

By way of examples of copolyamides, mention may be made of the following:

a) 6/12/IPD.6

in which:

6 denotes units resulting from the condensation of caprolactam,

12 denotes units resulting from the condensation of lauryllactam (2-azacyclotridecanone),

IPD.6 denotes units resulting from the condensation of isophoronediamine and adipic acid. The proportions by weight are 20/65/15, respectively.

The melting point is between 125° C. and 135° C.

b) 6/6,6/12

in which:

6 denotes units resulting from the condensation of caprolactam,

6,6 denotes hexamethyleneadipamide (hexamethylene diamine condensed with adipic acid) units.

12 denotes units resulting from the condensation of lauryllactam (2-azacyclotridecanone).

The proportions by weight are respectively 40/20/40.

The melting point is between 115° C. and 127° C.

c) pip.12/pip.9/11

in which:

pip.12 denotes units resulting from the condensation of piperazine and a C¹² diacid;

pip.9 denotes units resulting from the condensation of piperazine and a C⁹ diacid;

11 denotes units resulting from the condensation of aminoundecanoic acid,

the proportions be weight are 35/35/30, respectively.

The processes for manufacturing copolyamides are known from the prior art and these copolyamides may be manufactured by polycondensation, for example in an autoclave.

According to a third type the copolyamides are a blend of a 6/12 copolyamide rich in 6 and of a 6/12 copolyamide rich in 12. As regards the blend of PA-6/12 copolyamides, one comprising by weight more 6 than 12 and the other more 12 than 6, the PA-6/12 copolyamide results from the condensation of caprolactam with lauryllactam. It is clear that “6” denotes the units derived from caprolactam and “12” denotes the units derived from lauryllactam. It would not be outside the scope of the invention if caprolactam were to be replaced entirely or partly with aminocaproic acid, and likewise lauryllactam could be replaced with aminododecanoic acid. These copolyamides may include other units, provided that the ratio of the 6 and 12 proportions are respected.

Advantageously, the copolyamide rich in 6 comprises 60 to 90% by weight of 6 for 40 to 10% of 12, respectively.

Advantageously, the copolyamide rich in 12 comprises 60 to 90% by weight of 12 for 40 to 10% of 6, respectively.

As regards the proportions of the copolyamide rich in 6 and of the copolyamide rich in 12, these may be, by weight, from 40/60 to 60/40 and preferably 50/50.

These copolyamide blends may also include up to 30 parts by weight of other grafted polyolefins or (co)polyamides per 100 parts of copolyamides rich in 6 and rich in 12.

These copolyamides have a melting point (DIN 53736B standard) of between 60 and 200° C. and their relative solution viscosity may be between 1.3 and 2.2 (DIN 53727 standard; m-cresol solvent, 0.5 g/100 ml concentration, 25° C. temperature, Ubbelohde viscometer). Their melt rheology is preferably similar to that of the materials of the adjacent layers. These products are manufactured by the standard techniques for polyamides. Processes are described in U.S. Pat. Nos. 4,424,864; 4,483,975; 4,774,139; 5,459,230; 5,489,667; 5,750,232 and 5,254,641.

If the outer layer is made of PA-11, it is preferred that the tie between this PA-11 layer and the EVOH layer be based on functionalized polyolefins. If the outer layer is made of PA-12, it is preferred that the tie between this PA-12 layer and the EVOH layer be based on a copolyamide. The same applies for the tie between the inner layer and the layer of the blend of a polyamide and of a polyolefin having a polyamide matrix, that is to say if the inner layer is made of PA-11 the binder is preferably based on functionalized polyolefins and if the inner layer is made of PA-12 the binder is preferably based on a copolyamide.

With regard to the layer formed from EVOH copolymer, this may consist of EVOH or of an EVOH-based blend. EVOH is also referred to as a saponified ethylene/vinyl acetate copolymer. The saponified ethylene/vinyl acetate copolymer to be used according to the present invention is a copolymer having an ethylene content of 20 to 70 mol %, preferably 25 to 70 mol %, the degree of saponification of its vinyl acetate component not being less than 95 mol %. With an ethylene content of less than 20 mol %, the barrier properties under high-humidity conditions are not as high as would be desired, whereas an ethylene content exceeding 70 mol % results in reduced barrier properties. When the degree of saponification or hydrolysis is less than 95 mol %, the barrier properties are sacrificed.

The expression “barrier properties” is understood to mean the impermeability to gases and liquids, and in particular to oxygen and to petrol for motor vehicles.

Among these saponified copolymers, those which have melt flow indices within the 0.5 to 100 g/10 min. range are particularly useful. Advantageously, the MFI is chosen between 5 and 30 g/10 min. (at 230° C./2.16 kg), “MFI” is the abbreviation for “Melt Flow Index”.

It is known that this saponified copolymer may contain small amounts of other comonomer ingredients, including α-olefins, such as propylene, isobutene, α-octene, α-dodecene, α-octadecene, etc., unsaturated carboxylic acids or their salts, partial alkyl esters, complete alkyl esters, nitriles, amides and anhydrides of the said acids, and unsaturated sulphonic acids and salts thereof.

As regards the EVOH-based blends, these are such that the EVOH forms the matrix, that is to say it represents at least 40% and preferably at least 50% by weight of the blend. The other constituents of the blend are chosen from polyolefins, polyamides and possibly functional polymers.

As a first example of these EVOH-based blends, mention may be made of the following compositions (by weight):

55 to 99.5 parts of EVOH copolymer;

0.5 to 45 parts of polypropylene and compatibilizer, their proportions being such that the ratio of the amount of polypropylene to the amount of compatibilizer is between 1 and 5.

Advantageously, the radio of the MFI of the EVOH to the MFI of the polypropylene is greater than 5 and preferably between 5 and 25. Advantageously, the MFI of the polypropylene is between 0.5 and 3 (in g/10 min. at 230° C./ 2.16 kg). According to an advantageous embodiment, the compatibilizer is a polyethylene carrying grafted polyamide species and it results from the reaction of (i) a copolymer of ethylene and a grafted or copolymerized unsaturated monomer X with (ii) a polyamide. The copolymer of ethylene and a grafted or copolymerized unsaturated monomer X is such that X is copolymerized and it may be chosen from ethylene/maleic anhydride copolymers and ethylene/alkyl (meth)acrylate/maleic anhydride copolymers, these copolymers comprising from 0.2 to 10% by weight maleic anhydride and from 0 to 40% by weight alkyl (meth)acrylate. According to another advantageous embodiment, the compatibilizer is a polypropylene carrying grafted polyamide species which result from the reaction of (i) a propylene homopolymer or a propylene copolymer comprising a grafted or copolymerized, unsaturated monomer X with (ii) a polyamide. Advantageously, X is grafted. The monomer X is advantageously an unsaturated carboxylic acid anhydride such as, for example, maleic anhydride.

As a second example of these EVOH-based blends, mention may be made of the compositions comprising:

50 to 98% by weight of an EVOH copolymer;

1 to 50% by weight of a polyethylene;

1 to 15% by weight of a compatibilizer consisting of a blend of an LLDPE or metallocene polyethylene and a polymer chosen from elastomers, very low-density polyethylenes and metallocene polyethylenes, the blend being cografted by an unsaturated carboxylic acid or a functional derivative of this acid.

Advantageously, the compatibilizer is such that the MFI₁₀/MFI₂ ratio is between 5 and 20, where MFI₂ is the melt flow index at 190° C. with a load of 2.16 kg, measured according to ASTM D1238, and MFI₁₀ is the melt flow index at 190° C. with a load of 10 kg according to ASTM D1238.

As a third example of these EVOH-based blends, mention may be made of the compositions comprising:

50 to 98% by weight of an EVOH copolymer;

1 to 50% by weight of an ethylene/alkyl (meth) acrylate copolymer;

1 to 15% by weight of a compatibilizer resulting from the reaction of (i) a copolymer of ethylene and a grafted or copolymerized unsaturated monomer X with (ii) a copolyamide.

Advantageously, the copolymer of ethylene and a grafted or copolymerized unsaturated monomer X is such that X is copolymerized, and it is an ethylene/maleic anhydride copolymer or an ethylene/alkyl (meth)acrylate/maleic anhydride copolymer. Advantageously, these copolymers comprise from 0.2 to 10% by weight of maleic anhydride and from 0 to 40% by weight of alkyl (meth)acrylate.

With regard to the layer formed from a blend of a polyamide and a polyolefin having a polyamide matrix, polyamides are understood to mean products resulting from the condensation:

of one or more amino acids, such as aminocaproic, 7-aminoheptanoic, 11-aminoundecanoic and 12-aminododecanoic acids or of one or more lactams, such as caprolactam, oenantholactam and lauryllactam;

of one or more salts or mixtures of diamines, such as hexamethylenediamine, dodecamethylenediamine, metaxylylenediamine, bis-p(aminocyclohexyl)methane and trimethylhexamethylenediamine with diacids such as isophthalic, terephthalic, adipic, azelaic, suberic, sebacic and dodecanedicarboxylic acids.

By way of examples of a polyamide, mention may be made of PA-6 and PA-6,6.

It may also be advantageous to use copolyamides. Mention may be made of the copolyamides resulting from the condensation of at least two alpha, omega-aminocarboxylic acids or of two lactams or of a lactam and of an alpha, omega-aminocarboxylic acid. Mention may also be made of the copolyamides resulting from the condensation of at least one alpha, omega-aminocarboxylic acid (or a lactam), at least one diamine and at least one dicarboxylic acid.

By way of examples of lactams, mention may be made of those having from 3 to 12 carbon atoms in the main ring and possibly being substituted. Mention may be made, for example, of β,β-dimethylpropriolactam, α,α-dimethylpropriolactam, amylolactam, caprolactam, capryllactam and lauryllactam.

By way of examples of alpha, omega-aminocarboxylic acids, mention may be made of aminoundecanoic acid and aminododecanoic acid. By way of examples of dicarboxylic acids, mention may be made of adipic acid, sebacic acid, isophthalic acid, butanedioic acid, 1,4-cyclohexyldicarboxylic acid, terephthalic acid, the sodium or lithium salt of sulphoisophthalic acid, dimerized fatty acids (these dimerized fatty acids have a dimer content of at least 98% and are preferably hydrogenated) and dodecanedioic acid HOOC—(CH₂)₁₀—COOH.

The diamine may be an aliphatic diamine having from 6 to 12 atoms or it may be an aryl diamine and/or a saturated cyclic diamine. By way of examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diamino-hexane, diamine polyols, isophoronediamine (IPD), methylpentamethylene-diamine (MPDM), bis(aminocyclohexyi)methane (BACM) and bis(3-methyl-4 aminocyclohexyl)methane (BMACM).

By way of examples of copolyamides, mention may be made of copolymers of caprolactam and lauryllactam (PA-6/12), copolymers of caprolactam, adipic acid and hexamethylenediamine (PA-6/6,6), copolymers of caprolactam, lauryllactam, adipic acid and hexamethylenediamine (PA-6/12/6,6), copolymers of caprolactam, lauryllactam, 11-aminoundecanoic acid, azelaic acid and hexamethylenediamine (PA-6/6,9/11/12), copolymers of caprolactam, lauryllactam, 11-aminoundecanoic acid, adipic acid and hexamethylenediamine (PA-6/6,6/11/12) and copolymers of lauryllactam, azelaic acid and hexamethylenediamine (PA-6,9/12).

Advantageously, the copolyamide is chosen from PA-6/12 and PA-6/6,6. The advantage of these copolyamides is that their melting point is less than that of PA-6.

It is also possible to use any amorphous polyamide having no melting point.

The MFI of the polyamides and polyamide/polyolefin blends of the present invention is measured according to the rules of the art at a temperature of 15 to 20° C. above the melting point of the polyamide. With regard to compounds based on PA-6, the MFI is measured at 23° C./2.16 kg. With regard to compounds based on PA-6,6 the MFI is measured at 275° C./1 kg.

It is possible to use polyamide blends. Advantageously, the MFI of the polyamides is between 1 and 50 g/10 min.

It would not be outside the scope of the invention to replace part of polyamide (A) with a copolymer having polyamide blocks and polyether blocks, that is to say by using a blend comprising at least one of the above polyamides with at least one copolymer having polyamide blocks and polyether blocks.

Copolymers having polyamide blocks and polyether blocks have already been defined in the description of the plasticizers for the outer layer. The copolymers having polyamide blocks and polyether blocks have been described above.

As regards the polyolefin of this polyamide/polyolefin blend of the layer following the EVOH layer, this may or may not be functionalized or it may be a blend of at least one functionalized polyolefin and/or at least one unfunctionalized polyolefin. To simplify matters, functionalized polyolefins will be described below as (B1) and unfunctionalized polyolefins as (B2).

An unfunctionalized polyolefin (B2) is conventionally a homopolymer or a copolymer of alpha-olefins or diolefins, such as, for example, ethylene, propylene, 1-butene, 1-octene and butadiene. By way of examples, mention may be made of:

ethylene and copolymers homopolymers, particularly LDPE, HDPE, LLDPE (linear low-density polyethylene) or VLDPE (very low-density polyethylene) and, metallocene polyethylene;

propylene homopolymers and copolymers;

ethylene/alpha-olefin copolymers such as ethylene/propylene copolymers; EPRs (abbreviation for ethylene-propylene rubbers); and ethylene/propylene/diene copolymers (EPDM);

styrene-ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);

copolymers of ethylene with at least one product chosen from salts or esters of unsaturated carboxylic acids such as alkyl (meth)acrylate (for example methyl acrylate), or vinyl esters of saturated carboxylic acids such as vinyl acetate, the proportion of comonomer possibly being as much as 40% by weight.

The functionalized polyolefin (B1) may be an alpha-olefin polymer having reactive units (the functional groups); such reactive units are acid, anhydride or epoxy functional groups. By way of example, mention may be made of the above polyolefins (B2) which are grafted or are copolymerized or terpolymerized by unsaturated epoxides such as glycidyl (meth)acrylate, or by carboxylic acids or the corresponding salts or esters, such as (meth)acrylic acid (this possibly being completely or partially neutralized by metals such as Zn, etc.) or else by carboxylic acid anhydrides such as maleic anhydride. A functionalized polyolefin is, for example, a PE/EPR blend, the weight ratio of which may vary between wide limits, for example between 40/60 and 90/10, the said blend being cografted with an anhydride, especially maleic anhydride, with a degree of grafting, for example, of 0.01 to 5% by weight.

The functionalized polyolefin (B1) may be chosen from the following (co)polymers, grafted with maleic anhydride or glycidyl methacrylate, in which the degree of grafting is, for example, from 0.01 to 5% by weight:

PE, PP, copolymers of ethylene with propylene, butene, hexene, or octene and containing, for example, from 35 to 80% by weight of ethylene;

ethylene/alpha-olefin copolymers such as ethylene/propylene copolymers; EPRs (abbreviation for ethylene-propylene rubbers); and ethylene/propylene/diene copolymers (EPDM);

styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);

ethylene-vinyl acetate copolymers (EVA), containing up to 40% by weight of vinyl acetate;

ethylene-alkyl (meth)acrylate copolymers, containing up to 40% by weight of alkyl (meth)acrylate;

ethylene-vinyl acetate (EVA)-alkyl (meth)acrylate copolymers, containing up to 40% by weight of comonomers.

The functionalized polyolefin (B1) may also be chosen from ethylene/propylene copolymers containing predominantly propylene, these being grafted by maleic anhydride and then condensed with monoaminated polyamide (or polyamide oligomer) (products described in EP-A-0 342 066).

The functionalized polyolefin (B1) may also be a copolymer or terpolymer of at least the following units: (1) ethylene, (2) an alkyl (meth)acrylate or a vinyl ester of a saturated carboxylic acid and (3) an anhydride such as maleic anhydride or a (meth)acrylic acid or an epoxy such as glycidyl (meth)acrylate. By way of examples of functionalized polyolefins of this latter type, mention may be made of the following copolymers, in which the ethylene preferably represents at least 60% by weight and in which the termonomer (the functional group) represents, for example, from 0.1 to 10% by weight of the copolymer:

ethylene/alkyl (meth)acrylate/(meth)acrylic acid or maleic anhydride or glycidyl methacrylate copolymers;

ethylene/vinyl acetate/maleic anhydride or glycidyl methacrylate copolymers;

ethylene/vinyl acetate or alkyl (meth)acrylate/(meth)acrylic acid or maleic anhydride or glycidyl methacrylate copolymers.

In the above copolymers, the (meth)acrylic acid may be salified with Zn or Li.

The term “alkyl (meth)acrylate” in (B1) or (B2) denotes C₁ to C₈ alkyl methacrylates and acrylates, and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the aforementioned polyolefins (B1) may also be crosslinked by any suitable process or agent (diepoxy, diacid, peroxide, etc.); the term functionalized polyolefin also includes blends of the aforementioned polyolefins with a difunctional reactive agent such as a diacid, dianhydride, diepoxy, etc., which is capable of reacting with them or blends of at least two functionalized polyolefins able to react together.

The copolymers mentioned above, (B1) and (B2), may be copolymerized so as to form random or block copolymers and may have a linear or branched structure.

The molecular weight, the MFI index and the density of these polyolefins may also vary over a wide range, as those skilled in the art will appreciate. MFI is the abbreviation for Melt Flow Index. It is measured according to the ASTM 1238 standard.

Advantageously, the non-functionalized polyolefins (B2) are chosen from propylene homopolymers or copolymers and any ethylene homopolymer or copolymer of ethylene and a comonomer of higher alpha-olefin type, such as butene, hexene, octene or 4-methyl-1-pentene. Mention may be made, for example, of high-density PP and PE, medium-density PE, linear low-density PE, low-density PE and very low-density PE. These polyethylenes are known to those skilled in the art as being produced by a “radical” process, by “Ziegler”-type catalysis or, more recently, by so-called “metallocene” catalysis.

Advantageously, the functionalized polyolefins (B1) are chosen from any polymer comprising alpha-olefin units and units carrying polar reactive functional groups such as epoxy, carboxylic acid or carboxylic acid anhydride functional groups. By way of examples of such polymers, mention may be made of ethylene/alkyl acrylate/maleic anhydride or ethylene/alkyl acrylate/glycidyl methacrylate terpolymers, such as the LOTADER® polymers from the Applicant, or maleic-anhydride-grafted polyolefins such as the Orevac® polymers from the Applicant, as well as ethylene/alkyl acrylate/(meth)acrylic acid terpolymers. Mention may also be made of propylene homopolymers and copolymers grafted by a carboxylic acid anhydride and then condensed with polyamides or monoaminated polyamide oligomers.

The MFI of (A) and the MFIs of (B1) and (B2) may be chosen within a wide range; however, it is recommended, in order to facilitate the dispersion of (B), that the MFI of (A) be greater than that of (B).

For small proportions of (B), for example 10 to 15 parts, it is sufficient to use a non-functionalized polyolefin (B2). The proportion of (B2) and (B1) in the (B) phase depends on the amount of functional groups present in (B1) and on their reactivity. Advantageously, (B1)/(B2) weight ratios ranging from 5/35 to 15/25 are used. It is also possible, for low proportions of (B), to use only a blend of polyolefins (B1) in order to obtain crosslinking.

According to a first preferred embodiment of the invention, the polyolefin (B) comprises (i) a high-density polyethylene (HDPE) and (ii) a blend of a polyethylene (C1) and a polymer (C2) chosen from elastomers, very low-density polyethylenes and ethylene copolymers, the (C1)+(C2) blend being cografted by an unsaturated carboxylic acid.

According to a variant of this first embodiment of the invention, the polyolefin (B) comprises (i) a high-density polyethylene (HDPE), (ii) a polymer (C2) chosen from elastomers, very low-density polyethylenes and ethylene copolymers (C2) being grafted by an unsaturated carboxylic acid and (iii) a polymer (C′2) chosen from elastomers, very low-density polyethylenes and ethylene copolymers.

According to a second preferred embodiment of the invention, the polyolefin (B) comprises (i) polypropylene and (ii) a polyolefin which results from the reaction of a polyamide (C4) with a copolymer (C3) comprising propylene and an unsaturated monomer X, grafted or copolymerized.

According to a third preferred embodiment of the invention, the polyolefin (B) comprises (i) a polyethylene of the LLDPE, VLDPE or metallocene type and (ii) an ethylene/alkyl (meth)acrylate/maleic anhydride copolymer.

According to a fourth preferred embodiment of the invention, the polyamide (A) is chosen from blends of (i) a polyamide and (ii) a copolymer having PA-6 blocks and PTMG blocks and blends of (i) a polyamide and (ii) a copolymer having PA-12 blocks and PTMG blocks, the ratio of the amount of copolymer to the amount of polyamide by weight being between 10/90 and 60/40. According to a first variant, the polyolefin (B) comprises (i) a polyethylene of the LLDPE, VLDPE or metallocene type or (ii) an ethylene/alkyl (meth)acrylate/maleic anhydride copolymer; according to a second variant, the polyolefin comprises two functionalized polymers comprising at least 50 mol % of ethylene units and able to react in order to form a crosslinked phase.

With regard to the first embodiment, the proportions (by weight) are advantageously the following:

60 to 70% of polyamide,

5 to 15% of the cografted blend of (C1) and (C2),

the balance being high-density polyethylene.

With regard to the high-density polyethylene, its density is advantageously between 0.940 and 0.965 and the MFI between 0.1 and 5 g/10 min. (190° C./2.16 kg).

The polyethylene (C1) may be chosen from the abovementioned polyethylenes. Advantageously, (C1) is a high-density polyethylene (HDPE) having a density between 0.940 and 0.965. The MFI of (C1) is between 0.1 and 3 g/10 min. (190° C./2.16 kg).

The copolymer (C2) may, for example, be an ethylene/propylene elastomer (EPR) or ethylene/propylene/diene elastomer (EPDM). (C2) may also be a very low-density polyethylene (VLDPE) which is either an ethylene homopolymer or an ethylene/alpha-olefin copolymer. (C2) may also be a copolymer of ethylene with at least one product chosen from (i) unsaturated carboxylic acids, their salts and their esters, (ii) vinyl esters of saturated carboxylic acids and (iii) unsaturated dicarboxylic acids, their salts, their esters, their half-esters and their anhydrides. Advantageously (C2) is an EPR.

Advantageously, 60 to 95 parts of (C1) per 40 to 5 parts of (C2) are used.

The blend of (C1) and (C2) is grafted with an unsaturated carboxylic acid, that is to say (C1) and (C2) are cografted. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids.

Unsaturated dicarboxylic acids having 4 to 10 carbon atoms and their functional derivatives, particularly their anhydrides, are particularly preferred grafting monomers.

Advantageously maleic anhydride is used.

Various known processes can be used to graft a grafting monomer onto the blend of (C1) and (C2). For example, this may be achieved by heating the polymers (C1) and (C2) to a high temperature, about 150° C. to about 300° C., in the presence or absence of a solvent and with or without a radical initiator.

In the graft-modified blend of (C1) and (C2) obtained in the abovementioned manner, the amount of grafting monomer may be chosen appropriately, but it is preferably from 0,01 to 10% and better still from 600 ppm to 2%, with respect to the weight of grafted (C1)+(C2). The amount of grafted monomer is determined by assaying the succinic functional groups by FTIR spectroscopy. The MFI (190° C./2.16 kg) of the cografted (C1)+(C2) is 5 to 30 and preferably 13 to 20 g/10 min.

Advantageously, the cografted (C1)/(C2) blend is such that the MFI₁₀/MFI₂ ratio is greater than 18.5, MFI₁₀ denoting the melt flow index at 190° C. with a load of 10 kg and MFI₂ denoting the melt flow index with a load of 2.16 kg. Advantageously, the MFI₂₀ of the blend of the cografted polymers (C1) and (C2) is less than 24. MFI₂₀ denotes the melt flow index at 190° C. with a load of 21.6 kg.

With regard to the variant of the first embodiment, the proportions (by weight) are advantageously the following:

60 to 70% of polyamide,

5 to 10% of grafted (C2),

5 to 10% of (C′2),

the balance being high-density polyethylene.

Advantageously, (C2) is an EPR or an EPDM. Advantageously, (C′2) is an EPR containing 70 to 75% ethylene by weight.

With regard to the second embodiment of the invention, the proportions (by weight) are advantageously the following:

60 to 70% of polyamide,

20 to 30% of polypropylene,

3 to 10% of a polyolefin which results from the reaction of a polyamide (C4) with a copolymer (C3) comprising propylene and an unsaturated monomer X, grafted or copolymerized.

The MFI (230° C./2.16 kg) of the polypropylene is advantageously less than 0.5 g/10 min and preferably between 0.1 and 0.5 g/10 min. Such products are described in EP 647 681.

The grafted product of this second embodiment of the invention will now be described. Firstly, (C3) is prepared, this being either a copolymer of propylene and an unsaturated monomer X, or a polypropylene onto which an unsaturated monomer X is grafted. X is any unsaturated monomer that can be copolymerized with propylene or grafted onto the polypropylene and having a functional group capable of reacting with a polyamide. This functional group may, for example, be a carboxylic acid, a dicarboxylic acid anhydride or an epoxide. As examples of monomer X, mention may be made of (meth)acrylic acid, maleic anhydride and unsaturated epoxides such as glycidyl (meth)acrylate. Advantageously, maleic anhydride is used. With regard to the grafted polypropylenes, X may be grafted onto propylene homopolymers or copolymers, such as ethylene/propylene copolymers consisting predominantly (in moles) of propylene. Advantageously, (C3) is such that X is grafted. The grafting is an operation known per se.

(C4) is a polyamide or a polyamide oligomer. Polyamide oligomers are described in EP 342066 and FR 2291225. The polyamides (or oligomers) (C4) are products resulting from the condensation of the abovementioned monomers. Polyamide blends may be used. It is advantageous to use PA-6, PA-11, PA-12, a copolyamide having PA-6 units and PA-12 units (PA-6/12) and a copolyamide based on caprolactam, hexamethylenediamine and adipic acid PA-6/6,6). The polyamides or oligomers (C4) may have acid, amine or monoamine terminal groups. In order for the polyamide to have a monoamine terminal group, all that is required is to use a chain stopper of formula:

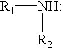

in which:

R₁ is hydrogen or a linear or branched alkyl group containing up to 20 carbon atoms;

R₂ is a linear or branched, alkyl or alkenyl, group having up to 20 carbon atoms, a saturated or unsaturated cycloaliphatic radical, an aromatic radical or a combination of the above. The chain stopper may, for example, be laurylamine or oleylamine.

Advantageously, (C4) is a PA-6, a PA-11 or a PA-12. The proportion by weight of C4 in C3+C4 is advantageously between 0.1 and 60%. The reaction of (C3) with (C4) preferably takes place in the melt state. For example, it is possible to mix (C3) and (C4) in an extruder at a temperature generally between 230 and 250° C. The average residence time of the melt in the extruder may be between 10 seconds and 3 minutes and preferably between 1 and 2 minutes.

With regard to the third embodiment, the proportions (by weight) are advantageously the following:

60 to 70% of polyamide,

5 to 15% of an ethylene/alkyl (meth)acrylate/maleic anhydride copolymer,

the balance being a polyethylene of the LLDPE, VLDPE or metallocene type; advantageously the density of this polyethylene is between 0.870 and 0.925, and the MFI is between 0.1 et 5 g/10 min. (190° C./2.16 kg).

Advantageously, the ethylene/alkyl (meth)acrylate/maleic anhydride copolymers comprise from 0.2 to 10% by weight of maleic anhydride and up to 40% and preferably 5 to 40% by weight of alkyl (meth)acrylate. Their MFIs are between 2 and 100 g/10 min. (190° C./2.16 kg). The alkyl (meth)acrylates have already been mentioned above. The melting point is between 80 and 120° C. These copolymers are commercially available. They are produced by radical polymerization at a pressure that may be between 200 and 2500 bar.

With regard to the fourth embodiment, the proportions (by weight) are advantageously the following:

According to a first variant:

60 to 70% of the blend of polyamide and copolymer having polyamide blocks and polyether blocks,

5 to 15% of an ethylene/alkyl (meth)acrylate/maleic anhydride copolymer,

the balance being a polyethylene of the LLDPE, VLDPE or metallocene type; advantageously, its density is between 0.870 and 0.925 and the MFI is between 0.1 and 5 g/10 min (190° C./2.16 kg).

Advantageously, the ethylene/alkyl (meth)acrylate/maleic anhydride copolymers comprise from 0.2 to 10% by weight of maleic anhydride and up to 40%, and preferably 5 to 40%, by weight of alkyl (meth)acrylate. Their MFIs are between 2 and 100 g/10 min, (190° C./2.16 kg). The alkyl (meth)acrylates have already been described above. The melting point is between 80 and 120° C. These copolymers are commercially available. They are produced by radical polymerization under pressure that can be between 200 and 2500 bar.

According to a second variant:

40 to 95% of the blend of polyamide and copolymer having polyamide blocks and polyether blocks;

60 to 5% of a blend of an ethylene/alkyl (meth)acrylate/maleic anhydride copolymer and an ethylene/alkyl (meth)acrylate/glycidyl methacrylate copolymer.

The anhydride-based copolymer was defined in the first variant. The ethylene/alkyl (meth)acrylate/glycidyl methacrylate copolymer may contain up to 40%, advantageously 5 to 40%, by weight of alkyl (meth)acrylate and up to 10%, preferably 0.1 to 8%, by weight of unsaturated epoxide. Advantageously, the alkyl (meth)acrylate is chosen from methyl (meth)acrylate, ethyl acrylate, n-butyl acrylate, isobutyl acrylate and 2-ethylhexyl acrylate. The amount of alkyl (meth)acrylate is preferably from 20 to 35%. The MFI is advantageously between 5 and 100 g/10 min. (190° C./2.16 kg) and the melting point is between 60 and 110° C. This copolymer can be obtained by radical copolymerization of the monomers.

It is possible to add catalysts for accelerating the reaction between the epoxide and anhydride functional groups; among the compounds capable of accelerating the reaction between the epoxide functional group and the anhydride functional group, mention may be made in particular of:

tertiary amines, such as dimethyllaurylamine, dimethylstéarylamine, N-butylmorpholine, N,N-dimethylcyclohexylamine, benzyldimethylamine, pyridine, dimethylamino-4-pyridine, methyl-1-imidazole, tetramethylethyl-hydrazine, Ia N,N-dimethylpiperazine, Ia N,N,N′,N′-tetramethyl-1,6-hexane-diamine a blend of tertiary amines having from 16 to 18 carbon atoms and known as dimethyltallowamine

tertiary phosphines, such as triphenylphosphine;

zinc alkyldithiocarbamates;

acids.

These polyamide/polyolefin blends may be manufactured by melt-blending the constituents using standard techniques for thermoplastics.

With regard to the PA-11 or PA-12 inner layer in contact with the petrol, this may, like the outer layer, be plasticized by standard plasticizers such as n-butylbenzenesulphonamide (BBSA) and copolymers comprising polyamide blocks and polyether blocks.

The polyamide contains an electrically conducting filler in an amount sufficient for the surface resistivity to be less than 10⁶ Ω/□. As examples of electrically conducting components, mention may be made of metals, metal oxides and carbon-based products. As examples of carbon-based products, mention may be made of graphite, carbon black aggregates, carbon fibres, carbon nanotubes and active carbons. It would not be outside the scope of the invention to use several components.

With regard to carbon black, the proportion is usually between 5 and 30 parts by weight of black per 100 parts of the combination of the polyamide and its plasticizers and other additives.

These multilayer tubes may be cylindrical with a constant diameter or may be annulate.

Conventionally, these tubes may include protective sheaths, especially made of rubber, in order to protect them from engine hotspots.

The entire disclosure of all applications, patents and publications, cited herein and of corresponding French Application No. 0115115, filed Nov. 22, 2001; and French Application No. 0201840, filed Feb. 14, 2002 are incorporated by reference herein.

1. A multilayer tube comprising, in a radial direction from outside inwards:
an outer layer of PA-11 or PA-12 polyamide,
a layer of a tie compound,
a layer of an EVOH,
a layer of a blend of a polyamide and a polyolefin having a polyamide matrix,
a layer of a tie compound,
an inner layer of PA-11 or PA-12 polyamide and including a dispersed electrically conducting filler producing a surface resistivity of less than 10⁶ Ω/□,
the layers being successive and adhering to one another in their respective contact region.

2. The tube according to claim 1, in which the inner layer contains carbon black in an amount sufficient to produce a surface resistivity of less than 10⁶ Ω/□.

3. The tube according to claim 1, in which the outer layer is PA-11 and the tie between this PA-11 layer and the EVOH layer comprises functionalized polyolefins.

4. The tube according to claim 1, in which the outer layer is PA-12 and the layer of tie compound between this PA-12 layer and the EVOH layer comprises copolyamides.

5. The tube according to claim 1, in which the inner layer is PA-11 and the layer of tie compound between this PA-11 layer and the layer of the blend of a polyamide and a polyolefin having a polyamide matrix comprises functionalized polyolefins.

6. The tube according to claim 1, in which the inner layer is PA-12 and the layer of tie compound between this PA-12 layer and the layer of the blend of a polyamide and a polyolefin having a polyamide matrix comprises copolyamides.

7. The tube according to claim 4, in which the copolyamides result from the condensation of at least two alpha, omega-aminocarboxylic acids or of at least two lactams having from 6 to 12 carbon atoms or of a lactam and an aminocarboxylic acid not having the same number of carbon atoms.

8. The tube according to claim 4, in which the copolyamides result from the condensation of at least one alpha, omega-aminocarboxylic acid, at least one lactam, or at least one diamine and at least one dicarboxylic acid.

9. The tube according to claim 4, in which the copolyamides are a first blend of 6/12 comprising 60 to 90% by weight of 6 and a second blend of 6/12 comprising 40 to 10% of 12.

10. The tube according to claim 4, in which the copolyamides are a first blend of 6/12 comprising 60 to 90% by weight of 12 and a second blend of 6/12 comprising 40 to 10% of 6.

11. The tube according to claim 9, in which the proportion of the first blend and the second blend are, by weight, from 40/60 to 60/40.

12. The tube according to claim 6, in which the copolyamides result from the condensation of at least two alpha, omega-aminocarboxylic acids or of at least two lactams having from 6 to 12 carbon atoms or of a lactam and an aminocarboxylic acid not having the same number of carbon atoms.

13. The tube according to claim 6, in which the copolyamides result from the condensation of at least one alpha, omega-aminocarboxylic acid, at least one lactam, or at least one diamine and at least one dicarboxylic acid.

14. The tube according to claim 6, in which the copolyamides are a first blend of 6/12 comprising 60 to 90% by weight of 6 and a second blend of 6/12 comprising 40 to 10% of 12.

15. The tube according claim 6, in which the copolyamides are a first blend of 6/12 comprising 60 to 90% by weight of 12 and a second blend of 6/12 comprising 40 to 10% of 6.

16. The tube according to claim 6, in which the proportion of the first blend and the second blend are, by weight, from 40/60 to 60/40.

17. The tube according to claim 1, in which the polyolefin of the blend of a polyamide and a polyolefin having a polyamide matrix comprises (i) a high-density polyethylene (HDPE) and (ii) a blend of a polyethylene (C1) and a polymer (C2) chosen from elastomers, very low-density polyethylenes and ethylene copolymers, the (C1)+(C2) blend being cografted by an unsaturated carboxylic acid.

18. The tube according claim 1, in which the polyolefin of the blend of a polyamide and a polyolefin having a polyamide matrix comprises (i) a high-density polyethylene (HDPE), (ii) a polymer (C2) which is an elastomer, very low-density polyethylene or ethylene copolymer (C2) grafted by an unsaturated carboxylic acid, and (iii) a polymer (C′2) which is an elastomer, very low-density polyethylene or an ethylene copolymer.

19. The tube according to claim 1, in which the polyolefin of the blend of a polyamide and a polyolefin having a polyamide matrix comprises (i) polypropylene and (ii) a polyolefin which results from the reaction of a polyamide (C4) with a copolymer (C3) comprising propylene and an unsaturated monomer X.

20. The tube according to claim 1, in which the polyolefin of the blend of a polyamide and a polyolefin having a polyamide matrix of the third layer comprises (i) an LLDPE, VLDPE or metallocene polyethylene and (ii) an ethylene/alkyl (meth)acrylate/maleic anhydride copolymer.

21. The tube according to claim 1, in which the polyamide of the blend of a polyamide and a polyolefin having a polyamide matrix is a blend of (i) a polyamide and (ii) a copolymer having PA-6 blocks and PTMG blocks; or a blend of (i) a polyamide and (ii) a copolymer having PA-12 blocks and PTMG blocks; the ratio of the amount of copolymer to the amount of polyamide by weight being between 10/90 and 60/40.

22. The tube according to claim 21, in which the polyolefin of the blend of a polyamide of a polyolefin having a polyamide matrix comprises (i) a LLDPE, VLDPE or metallocene polyolefin and (ii) an ethylene/alkyle (meth)acrylate/maleic anhydride copolymer.

23. The tube according to claim 21, in which the polyolefin of the blend of a polyamide and a polyolefin having a polyamide matrix comprises two functionalized polymers containing at least 50 mol % of ethylene units and able to react in order to form a crosslinked phase.
